(19) United States
(12) Patent Application Publication
(10) Pub. No.: US 2024/0058902 A1
(43) Pub. Date: Feb. 22, 2024

(54) OVERLAY WELDING METHOD

(71) Applicant: MITSUBISHI HEAVY INDUSTRIES, LTD., Tokyo (JP)

(72) Inventors: Daichi Masuyama, Tokyo (JP); Kazuhiko Kamo, Tokyo (JP); Mikihisa Ishihara, Tokyo (JP); Toshihide Kumagai, Tokyo (JP); Noriyuki Sakakibara, Tokyo (JP)

(73) Assignee: MITSUBISHI HEAVY INDUSTRIES, LTD., Tokyo (JP)

(21) Appl. No.: 18/219,940

(22) Filed: Jul. 10, 2023

(30) Foreign Application Priority Data
Aug. 17, 2022 (JP) 2022-130111

(51) Int. Cl. B23K 35/30

(52) U.S. Cl. CPC B23K 35/3046; B23K 35/308; B23K 2103/04

(57) ABSTRACT

A method of performing overlay welding on a member including a steel material and an overlay welded portion made of a cobalt-based alloy and formed on the steel material, the method including generating an arc between a welding torch and the overlay welded portion, forming a melt pool by melting a surface of the overlay welded portion with the arc, and simultaneously inserting a similar-composition welding material having a composition similar to the steel material and a cobalt-based alloy welding material made of a cobalt-based alloy into the melt pool.

### CROSS-REFERENCE TO RELATED APPLICATIONS

This application claims the benefit of priority to Japanese Patent Application Number 2022-130111 filed on Aug. 17, 2022. The entire contents of the above-identified application are hereby incorporated by reference.

### TECHNICAL FIELD

The disclosure relates to an overlay welding method.

### RELATED ART

As a method of performing surface hardening treatment on a steel material, there is a method of performing overlay welding using a hard material.

WO/2008/111150 discloses a valve gear including a bearing having a sliding surface against which a valve stem slides. The bearing has a plasma powder overlay weld layer made of a heat-resistant cobalt-based alloy and formed on the sliding surface against which the valve stem slides. The plasma powder overlay weld layer includes a first weld layer formed on a surface of the bearing and having a dilution ratio of 5 to 25%, and a second weld layer formed on the first weld layer and having a dilution ratio of 50% or less of the dilution ratio of the first welding layer.

JP 2018-1172 A discloses a cured overlay layer forming method including filling a hollow metal pipe having a predetermined length with hard particles and closing both ends of the hollow pipe, horizontally laying the hollow pipe on a metal base material, generating an arc between an electrode of a welding torch and the hollow pipe by causing the welding torch to approach above the hollow pipe, forming a melt pool by melting surfaces of the hollow pipe and the base material with the arc to cause unmelted hard particles to outflow from inside the hollow pipe into the melt pool after the hollow pipe is melted, and moving the welding torch along the hollow pipe, thereby forming a cured overlay layer on the surface of the base material along a movement trajectory of the welding torch.

### SUMMARY

For sliding surfaces and contact surfaces of internal components of main valves in a steam turbine or the like, wear resistance is improved by applying a cobalt-based alloy (e.g., Stellite), which is a considerably hard material, through overlay welding. In order to suppress cracking due to age hardening, it is necessary to control a dilution ratio (a parameter indicating to what extent the components of a base material have dissolved in a weld metal) of the overlay welded portion. The dilution ratio is also controlled in repair welding of the overlay welded portion. However, the overlay welded portion is made of a cobalt-based alloy which melts, while the base material does not melt. For this reason, there is no dilution with the base material in repairing the overlay welded portion, and thus it is difficult to control the dilution ratio within a specified range. Each of the overlay welding methods disclosed in WO/2008/111150 and JP 2018-1172 A is a method of performing welding on a material to be welded (base material), in which the base material is directly melted. However, in performing repair welding on a weld layer made of a cobalt-based alloy, the base material (steel material) is not directly melted. Accordingly, the dilution ratio of the repair welded portion is reduced, and thus it may not be possible to suppress cracking of the repair welded portion.

The disclosure has been made to solve the above-described problem, and an object thereof is to provide an overlay welding method of adding a component (e.g., Fe) that becomes insufficient at a repair welded portion formed by repair welding of a weld layer made of a cobalt-based alloy to a welding material, to thereby suppress a reduction in a dilution ratio.

A method of performing overlay welding on a member including a steel material according to the disclosure and an overlay welded portion made of a cobalt-based alloy and formed on the steel material, the method including generating an arc between a welding torch and the overlay welded portion, forming a melt pool by melting a surface of the overlay welded portion with the arc, and simultaneously inserting a similar-composition welding material having a composition identical or similar to the steel material and a cobalt-based alloy welding material made of a cobalt-based alloy into the melt pool.

With the overlay welding method according to the disclosure, it is possible to suppress a reduction in a dilution ratio of a repair welded portion formed by repair welding of a cobalt-based alloy.

### BRIEF DESCRIPTION OF DRAWINGS

The disclosure will be described with reference to the accompanying drawings, wherein like numbers reference like elements.

FIG. 1 is an enlarged perspective view of a removed region and the surroundings thereof in an overlay welding method according to a first embodiment.

FIG. 2 is an enlarged cross-sectional view of a melt pool and the surroundings thereof in the overlay welding method according to the first embodiment.

FIG. 3 is an enlarged cross-sectional view of a melt pool and the surroundings thereof in an overlay welding method according to a second embodiment.

FIG. 4 is an enlarged cross-sectional view of a removed region and the surroundings thereof in Comparative Example 1.

FIG. 5 is an enlarged cross-sectional view of a removed region and the surroundings thereof in Comparative Example 2.

FIG. 6 is an enlarged cross-sectional view of a removed region and the surroundings thereof in Comparative Example 3.

### DESCRIPTION OF EMBODIMENTS

### First Embodiment

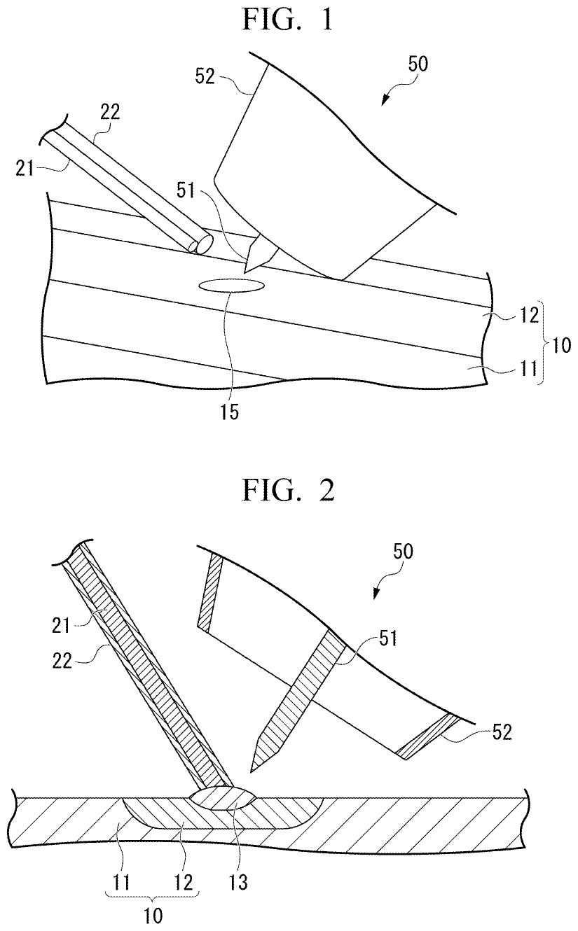

An overlay welding method of the disclosure will be described below. FIG. 1 is an enlarged perspective view of a removed region and the surroundings thereof in an overlay welding method according to a first embodiment.

The overlay welding method of the disclosure is a method of performing overlay welding on a member 10 including a steel material 11 and an overlay welded portion 12 made of a cobalt-based alloy and formed on the steel material 11, the method including generating an arc between a welding torch 50 and the overlay welded portion 12, forming a melt pool by melting a surface of the overlay welded portion 12 with the arc, and simultaneously inserting a similar-composition welding material 21 having a composition identical or similar to the steel material 11 and a cobalt-based alloy welding material 22 made of a cobalt-based alloy into the melt pool. Here, a dilution ratio is a parameter indicating to what extent the components of the steel material have dissolved in a weld metal, and generally refers to a value obtained by B/A×100(%), where A is a total amount of the weld metal and B is an amount of the steel material dissolved in the weld metal. However, in order to apply the above equation, it is necessary to cut the weld metal. Since it is impossible to cut an actual product, the dilution ratio in the disclosure is a value obtained by calculating the ratio of at least one component Y (e.g., Fe value) in the weld metal to at least one component X (e.g., Fe value) in the steel material in percentage, and is obtained by Y/X×100(%). Note that the weld metal in the disclosure refers to a metal of a repair welded portion formed by melting and welding the similar-composition welding material 21 and the cobalt-based alloy welding material 22. Hereinafter, the overlay welding method according to the first embodiment will be described.

### Member 10

The member 10 includes the steel material 11 and the overlay welded portion 12 made of a cobalt-based alloy and formed on the steel material 11.

### Steel Material

As the steel material 11, a 9Cr stainless steel, a 12Cr stainless steel, or the like can be used. The chemical composition of the 9Cr stainless steel is, for example, C: 0.06 to 0.12 mass %, Si: 0.2 to 0.5 mass %, Mn: 0.3 to 0.6 mass %, P: 0.02 mass % or less, S: 0.01 mass % or less, Ni: 0.4 mass % or less, Cr: 8.0 to 9.5 mass %, Mo: 0.85 to 1.05 mass %, and the balance: Fe and impurities. The chemical composition of the 12Cr stainless steel is, for example, C: 0.06 to 0.13 mass %, Si: 0.5 mass % or less, Mn: 0.6 mass % or less, P: 0.03 mass % or less, S: 0.04 mass % or less, Ni: 0.5 mass % or less, Cr: 12.0 to 13.5 mass %, Mo: 0.6 mass % or less, and the balance: Fe and impurities.

### Overlay Welded Portion

The overlay welded portion 12 is made of a cobalt-based alloy. The overlay welded portion 12 is a portion formed by solidification of a metal melted during welding, and the overlay welded portion 12 does not include a heat-affected portion (a portion between the steel material 11 and the overlay welded portion 12 where heat was input). Here, the cobalt-based alloy is an alloy containing 50 mass % or more of cobalt. The overlay welded portion 12 is, for example, a welded portion formed by performing overlay welding on the steel material 11 using the cobalt-based alloy welding material 22 made of a cobalt-based alloy. The overlay welded portion 12 is preferably harder than the steel material 11.

### Melt Pool Formation Region

A region where a melt pool is to be formed (melt pool formation region) is located on the overlay welded portion 12. For example, the melt pool formation region is preferably a region obtained by removing a part of the overlay welded portion 12 so as not to expose the steel material 11. Specifically, the melt pool formation region is a removed region 15 obtained by removing a defective portion of the overlay welded portion 12 with a cutter or the like.

### Similar-Composition Welding Material

The similar-composition welding material 21 has a chemical composition identical or similar to that of the steel material 11. When the steel material 11 is a 9Cr stainless steel, a weld material having a chemical composition identical or similar to the chemical composition of the 9Cr stainless steel of the steel material 11 is used.

The shape of the similar-composition welding material 21 is not particularly limited, and may be, for example, a rod shape or a wire shape. Preferably, the similar-composition welding material 21 has a rod shape. When the similar-composition welding material 21 has a rod shape or a wire shape, a diameter d1 of the similar-composition welding material 21 is not particularly limited. The diameter d1 of the similar-composition welding material 21 can be appropriately selected according to a purpose.

### Cobalt-Based Alloy Welding Material 22

The cobalt-based alloy welding material 22 is made of a cobalt-based alloy. The cobalt-based alloy refers to an alloy in which the content of cobalt is 50 mass % or more of the total mass. As the cobalt-based alloy welding material 22, Stellite (registered trademark), Tribaloy (registered trademark), or the like can be used. Examples of Stellite include Stellite 1 (Cr: 31 mass %, W: 13 mass %, C: 2.3 mass %, Si: 1.3 mass %, and the balance: Co), Stellite 6 (Cr: 28.5 mass %, W: 4.5 mass %, C: 1.1 mass %, Si: 1.2 mass %, the balance: Co), Stellite 12 (Cr: 28.5 mass %, W: 7.7 mass %, C: 1.4 mass %, Si: 1.2 mass %, and the balance: Co), Stellite 20 (Cr: 35 mass %, W: 18 mass %, C: 3.2 mass %, Si: 0.6 mass %, and the balance: Co), Stellite 21 (Cr: 26 mass %, C: 0.22 mass %, Ni: 3 mass %, Mo: 5.8 mass %, Si: 1.2 mass %, and the balance: Co), and Stellite 32 (Cr: 26 mass %, W: 13 mass %, C: 1.95 mass %, Si: 1.2 mass %, and the balance: Co). The cobalt-based alloy welding material 22 is preferably the same as the material (welding material) used to form the overlay welded portion 12.

The shape of the cobalt-based alloy welding material 22 is not particularly limited, and may be, for example, a rod shape or a wire shape. Preferably, the cobalt-based alloy welding material 22 has a rod shape. When the cobalt-based alloy welding material 22 has a rod shape or a wire shape, a diameter d2 of the cobalt-based alloy welding material 22 is not particularly limited. The diameter d2 of the cobalt-based alloy welding material 22 can be appropriately selected according to a purpose.

The ratio between the diameter d2 of the cobalt-based alloy welding material 22 and the diameter d1 of the similar-composition welding material 21 (d2:d1) is preferably 70:30 to 60:40. More preferably, the ratio between the diameter d2 of the cobalt-based alloy welding material 22 and the diameter d1 of the similar-composition welding material 21 is 65:35 to 60:40. By setting the ratio between the diameter d2 of the cobalt-based alloy welding material 22 and the diameter d1 of the similar-composition welding material 21 within the above range, a reduction in a dilution ratio of a repair welded portion can be further suppressed.

### Welding Torch 50

The welding torch 50 includes a nozzle 52 having an open tip and an electrode 51 disposed on the central axis of the nozzle 52. The welding torch 50 is preferably a tungsten inert gas (TIG) welding torch. In the case of TIG welding, the electrode 51 is a tungsten electrode. In the case of TIG welding, an inert gas (such as Ar) is supplied into the nozzle 52. while the inert gas is supplied, an arc is generated between the welding torch 50 and the overlay welded portion 12 to form a melt pool by melting a surface of the overlay welded portion 12 with the arc.

Next, welding conditions will be described. FIG. 2 is an enlarged cross-sectional view of a melt pool and the surroundings thereof in the overlay welding method according to the first embodiment. As illustrated in FIG. 2, an arc is generated between the welding torch 50 and the overlay welded portion 12, a melt pool 13 is formed by melting a surface of the overlay welded portion 12 by the generated arc, and the similar-composition welding material 21 having a composition identical or similar to the steel material 11 and the cobalt-based alloy welding material 22 made of a cobalt-based alloy are simultaneously inserted into the melt pool 13. As a result of solidification of the melt pool 13, a repair welded portion can be formed in the removed region of the overlay welded portion 12.

### Preheating

In the overlay welding method according to the first embodiment, it is preferable to preheat a region to be welded (e.g., the removed region 15) and the surroundings thereof in the member 10 before performing overlay welding. A preheating temperature is, for example, 200° C. to 300° C. By performing the preheating, cracking of the repair welded portion and a surrounding base material portion can be suppressed.

### Arc Welding

In the overlay welding method according to the first embodiment, a welding method is not particularly limited as long as the welding method is arc welding that generates an arc. Examples of the arc welding include TIG welding, plasma welding, and the like. TIG welding is particularly preferable as the arc welding.

### Welding Current

Welding current for the overlay welding method according to the first embodiment is not particularly limited as long as overlay welding can be performed. The welding current is, for example, 50 to 100 A.

### Inert Gas

In the overlay welding method according to the first embodiment, it is preferable to flow inert gas (shielding gas). The inert gas is, for example, Ar. A flow rate of the shielding gas is not particularly limited. For example, the flow rate of the shielding gas is 8 to 12 L/min.

Method of Inserting Similar-Composition Welding Material 21 and Cobalt-Based Alloy Welding Material 22 into Melt Pool

In the first embodiment, preferably, the similar-composition welding material 21 is inserted into the melt pool 13 while in contact with the cobalt-based alloy welding material 22. By inserting the similar-composition welding material 21 into the melt pool 13 while in contact with the cobalt-based alloy welding material 22, a reduction in the dilution ratio of the repair welded portion can be further suppressed. A method of bringing the similar-composition welding material 21 and the cobalt-based alloy welding material 22 into contact with each other is not particularly limited. For example, the similar-composition welding material 21 may be brought into contact with the cobalt-based alloy welding material 22 by fixing the similar-composition welding material 21 and the cobalt-based alloy welding material 22 using a jig.

In the first embodiment, preferably, the similar-composition welding material 21 and the cobalt-based alloy welding material 22 are inserted into the melt pool 13 such that, along a thickness direction of the base material, a distance from a surface of the melt pool 13 to the center of the similar-composition welding material 21 is substantially equal to a distance from the surface of the melt pool 13 to the center of the cobalt-based alloy welding material 22. By inserting the similar-composition welding material 21 and the cobalt-based alloy welding material 22 into the melt pool 13 in this way, a variation in a dilution ratio of a repair welded portion can be further suppressed.

A method of inserting the similar-composition welding material 21 and the cobalt-based alloy welding material 22 into the melt pool 13 such that, along a thickness direction of the base material, a distance from a surface of the melt pool 13 to the center of the similar-composition welding material 21 is substantially equal to a distance from the surface of the melt pool 13 to the center of the cobalt-based alloy welding material 22 is not particularly limited. Along the thickness direction of the base material, the distance from the surface of the melt pool 13 to the center of the similar-composition welding material 21 may be equal to the distance from the surface of the melt pool 13 to the center of the cobalt-based alloy welding material 22. For example, the similar-composition welding material 21 and the cobalt-based alloy welding material 22 can be substantially simultaneously inserted into the melt pool 13 by the following method. First, the similar-composition welding material 21 and the cobalt-based alloy welding material 22 are fixed by using a jig or the like to bring the similar-composition welding material 21 into contact with the cobalt-based alloy welding material 22. Next, insertion into the melt pool 13 is performed such that, along a thickness direction of the base material, a distance from a surface of the melt pool 13 to the center of the similar-composition welding material 21 is substantially equal to a distance from the surface of the melt pool 13 to the center of the cobalt-based alloy welding material 22. The center of the similar-composition welding material 21 is a center in a cross-section perpendicular to a longitudinal direction of the similar-composition welding material 21. When the similar-composition welding material 21 has a rod shape or a wire shape, the center of the similar-composition welding material 21 is the center of a circle. Similarly, the center of the cobalt-based alloy welding material 22 is a center in a cross-section perpendicular to a longitudinal direction of the cobalt-based alloy welding material 22. When the cobalt-based alloy welding material 22 has a rod shape or a wire shape, the center of the cobalt-based alloy welding material 22 is the center of a circle.

Heating (post-heating) may be performed using a gas burner or the like immediately after completion of the welding (after formation of the repair welded portion). A heating temperature is, for example, 300 to 400° C. After the post-heating, the member 10 is preferably gradually cooled by being covered with a glass cloth or the like.

Preferably, the dilution ratio is checked after completion of the welding or after gradual cooling following the post-heating. The dilution ratio can be obtained by measuring the value of a specific element (e.g., Fe) in the repair welded portion using a fluorescent X-ray measurement device for positive material identification (PMI) inspection. The dilution ratio is appropriately set according to an application. For example, the dilution ratio is 10% or more and 30% or less.

### Operational Effects

In the first embodiment described above, in performing repair welding of an overlay welded portion made of a cobalt-based alloy, a component that becomes insufficient in a repair welded portion to be formed by the repair welding is added to a welding material so that a reduction in a dilution ratio can be suppressed. In addition, in the overlay welding method according to the first embodiment, the similar-composition welding material 21 is inserted into the melt pool 13 while in contact with the cobalt-based alloy welding material 22. Accordingly, a reduction in the dilution ratio of the repair welded portion can be further suppressed. Further, in the overlay welding method according to the first embodiment, the similar-composition welding material 21 and the cobalt-based alloy welding material 22 are inserted into the melt pool 13 such that, along a thickness direction of the base material, a distance from a surface of the melt pool 13 to the center of the similar-composition welding material 21 is substantially equal to a distance from the surface of the melt pool 13 to the center of the cobalt-based alloy welding material 22. Accordingly, a variation in the dilution ratio of the repair welded portion can be suppressed.

### Second Embodiment

An overlay welding method of the disclosure will be described below. Hereinafter, contents different from those of the first embodiment will be described, and detailed descriptions common to the overlay welding method according to the first embodiment will be omitted.

Method of Inserting Similar-Composition Welding Material 21 and Cobalt-Based Alloy Welding Material 22 into Melt Pool

In an overlay welding method according to a second embodiment, the similar-composition welding material 21 is inserted into the melt pool 13 while in contact with the cobalt-based alloy welding material 22. By inserting the similar-composition welding material 21 into the melt pool 13 while in contact with the cobalt-based alloy welding material 22, a reduction in the dilution ratio of the repair welded portion can be further suppressed. A method of bringing the similar-composition welding material 21 and the cobalt-based alloy welding material 22 into contact with each other is not particularly limited. For example, the similar-composition welding material 21 may be brought into contact with the cobalt-based alloy welding material 22 by fixing the similar-composition welding material 21 and the cobalt-based alloy welding material 22 using a jig.

Either of the similar-composition welding material 21 and the cobalt-based alloy welding material 22 is inserted into the melt pool 13 first. Even when either of the similar-composition welding material 21 and the cobalt-based alloy welding material 22 is inserted into the melt pool 13 first, a reduction in the dilution ratio of the repair welded portion can be suppressed.

A method of inserting either of the similar-composition welding material 21 and the cobalt-based alloy welding material 22 into the melt pool 13 first is not particularly limited. For example, either of the similar-composition welding material 21 and the cobalt-based alloy welding material 22 can be inserted into the melt pool 13 first by the following method. First, the similar-composition welding material 21 and the cobalt-based alloy welding material 22 are fixed by using a jig or the like to bring the similar-composition welding material 21 into contact with the cobalt-based alloy welding material 22. Next, insertion into the melt pool 13 is performed such that, along a thickness direction of the base material, a distance from a surface of the melt pool 13 to the center of the similar-composition welding material 21 is different from a distance from the surface of the melt pool 13 to the center of the cobalt-based alloy welding material 22.

### Operational Effects

In the second embodiment described above, in performing repair welding of an overlay welded portion 12 made of a cobalt-based alloy, a component that becomes insufficient in a repair welded portion to be formed by the repair welding is added to a welding material so that a reduction in a dilution ratio can be suppressed. In addition, in the overlay welding method according to the second embodiment, the similar-composition welding material 21 is inserted into a melt pool 13 while in contact with the cobalt-based alloy welding material 22. Accordingly, a reduction in the dilution ratio of the repair welded portion can be further suppressed. Further, in the overlay welding method according to the second embodiment, either of the similar-composition welding material 21 and the cobalt-based alloy welding material 22 is inserted into the melt pool 13 first. When the insertion is performed in this manner, the melt amount of either of the similar-composition welding material 21 and the cobalt-based alloy welding material 22 is increased. Thus, the insertion method can be appropriately changed according to the shape and the dilution ratio of a welding portion. With the overlay welding method according to the second embodiment, a reduction in the dilution ratio of the repair welded portion can be suppressed even when either of the welding materials is inserted into the melt pool 13 first.

The overlay welding methods of the disclosure have been described above. According to the overlay welding methods of the disclosure, in performing repair welding of an overlay welded portion made of a cobalt-based alloy, a reduction in the dilution ratio of a repair welded portion formed by the repair welding can be suppressed.

It should be noted that the technical scope of the disclosure is not limited to the embodiments described above, and various modifications may be made without departing from the spirit of the disclosure. In addition, the constituent elements in the embodiments described above can be replaced as appropriate with commonly known constituent elements, without departing from the spirit of the disclosure.

### EXAMPLES

Next, Examples of the disclosure will be described. Conditions in Examples constitute only example conditions employed to confirm the enablement and effects of the disclosure, and the disclosure is not limited to these example conditions. The disclosure can employ various conditions as long as the object of the disclosure is achieved without departing from the gist of the disclosure.

### Example 1

As the member 10, a member in which the overlay welded portion 12 was formed on a 9Cr stainless steel (9.0% Cr-1.0% Mo steel (ASTMA182MF91)) or a 12Cr stainless steel of the steel material 11 was prepared. The composition of the steel material 11 is shown in Table 1. The overlay welded portion 12 of Example 1 was formed by plasma powder overlay welding using a powder of Co: 55 mass %, Cr: 25 mass %, and Ni: 3 mass %. In Examples below, results of the 9Cr stainless steel will be indicated.

TABLE 1

| Steel | | | | | | | | | | | | | | | |
|---|---|---|---|---|---|---|---|---|---|---|---|---|---|---|---|
| material | C | Si | Mn | P | S | Ni | Cr | Mo | Cu | V | Cb | Ti | Al | N | Zr |
| 9Cr steel | 0.10 | 0.32 | 0.45 | 0.016 | 0.001 | 0.19 | 9.19 | 0.97 | — | 0.22 | 0.07 | <0.01 | 0.01 | 0.057 | <0.01 |
| 12Cr steel | 0.12 | 0.27 | 0.34 | 0.015 | 0.001 | 0.10 | 12.75 | 0.32 | 0.03 | — | — | — | — | — | — |

As the similar-composition welding material 21, a material having a chemical composition identical to the steel material 11 was prepared. As the cobalt-based alloy welding material 22, a welding rod containing Co: 55 mass %, Cr: 25 mass %, and Ni: 3 mass % used for forming the overlay welded portion 12 was prepared. Both of the cobalt-based alloy welding material 22 and the similar-composition welding material 21 were rod-shaped, and the ratio between the diameter of the cobalt-based alloy welding material 22 and the diameter of the similar-composition welding material 21 (diameter of the cobalt-based alloy welding material 22: diameter of the similar-composition welding material 21) was 60:40. The similar-composition welding material 21 was fixed to the cobalt-based alloy welding material 22 by using a jig. First, the removed region 15 was formed by removing a part of the overlay welded portion 12 on a surface of the member 10 so as not to expose the steel material 11. Next, the removed region 15 was heated at 200 to 300° C. by using a gas burner. The removed region 15 was inspected with a fluorescent X-ray measurement device for PMI inspection, and it was confirmed that the steel material 11 was not exposed.

After the heating, the welding torch (electrode: tungsten) 50 was caused to approach the removed region 15 to generate an arc between the welding torch 50 and the removed region 15, and the melt pool 13 was formed by melting a surface of the overlay welded portion 12 with the arc.

After the melt pool 13 was formed, the similar-composition welding material 21 and the cobalt-based alloy welding material 22 were simultaneously inserted into the melt pool 13. Specifically, as illustrated in FIG. 2, insertion into the melt pool 13 was performed such that, along a thickness direction of the base material, a distance from a surface of the melt pool 13 to the center of the similar-composition welding material 21 was substantially equal to a distance from the surface of the melt pool 13 to the center of the cobalt-based alloy welding material 22. Weld current was 50 to 100 A, Ar was used as a shielding gas, and a flow rate was 8 to 12 L/min. A repair welded portion was formed by the above-described welding.

### Example 2

The member 10, the similar-composition welding material 21, and the cobalt-based alloy welding material 22 same as those in Example 1 were prepared. The removed region 15 was formed by removing a part of the overlay welded portion 12 on a surface of the member 10 so as not to expose the steel material 11. Next, the removed region 15 was heated at 200 to 300° C. by using a gas burner. The removed region 15 was inspected with a fluorescent X-ray measurement device designed for PMI inspection, and it was confirmed that the steel material 11 was not exposed.

After the heating, the welding torch (electrode: tungsten) 50 was caused to approach the removed region 15 to generate an arc between the welding torch 50 and the removed region 15, and the melt pool 13 was formed by melting a surface of the overlay welded portion 12 with the arc.

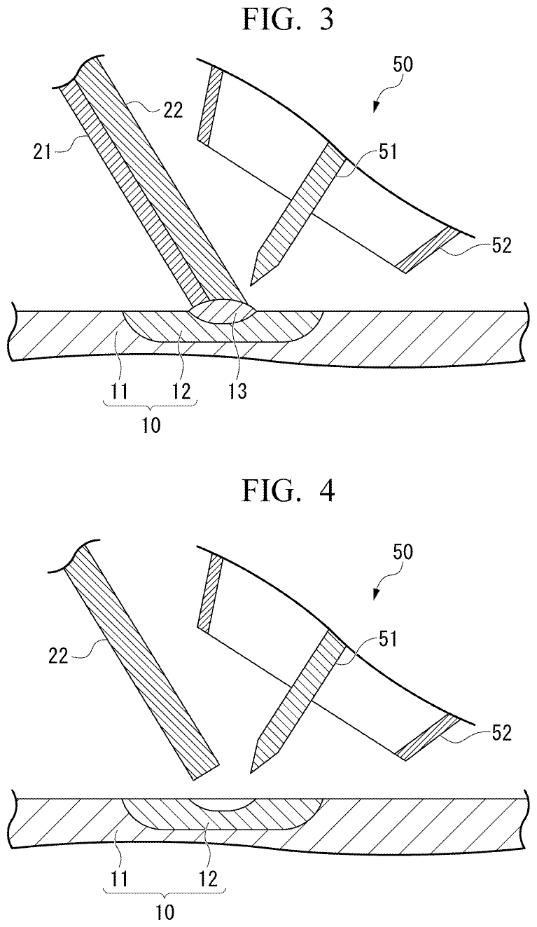

After the melt pool 13 was formed, the similar-composition welding material 21 and the cobalt-based alloy welding material 22 were simultaneously inserted into the melt pool 13. Specifically, as illustrated in FIG. 3, the similar-composition welding material 21 was placed under the cobalt-based alloy welding material 22 so that the similar-composition welding material 21 entered the melt pool 13 ahead of the cobalt-based alloy welding material 22. Weld current was 50 to 100 A, Ar was used as a shielding gas, and a flow rate was 8 to 12 L/min. A repair welded portion was formed by the above-described welding.

### Comparative Example 1

The member 10 and the cobalt-based alloy welding material 22 same as those in Example 1 were prepared. In Comparative Example 1, only the cobalt-based alloy welding material 22 was used as illustrated in FIG. 4. The removed region 15 was formed by removing a part of the overlay welded portion 12 on a surface of the member 10 so as not to expose the steel material 11. Next, the removed region 15 was heated at 200 to 300° C. by using a gas burner. The removed region 15 was inspected with a fluorescent X-ray measurement device designed for PMI inspection, and it was confirmed that the steel material 11 was not exposed.

After the heating, the welding torch (electrode: tungsten) 50 was caused to approach the removed region 15 to generate an arc between the welding torch 50 and the removed region 15, and the melt pool 13 was formed by melting a surface of the overlay welded portion 12 with the arc.

After the melt pool 13 was formed, a repair welded portion was formed by inserting only the cobalt-based alloy welding material 22 into the melt pool 13. Weld current was 50 to 100 A, Ar was used as a shielding gas, and a flow rate was 8 to 12 L/min.

### Comparative Example 2

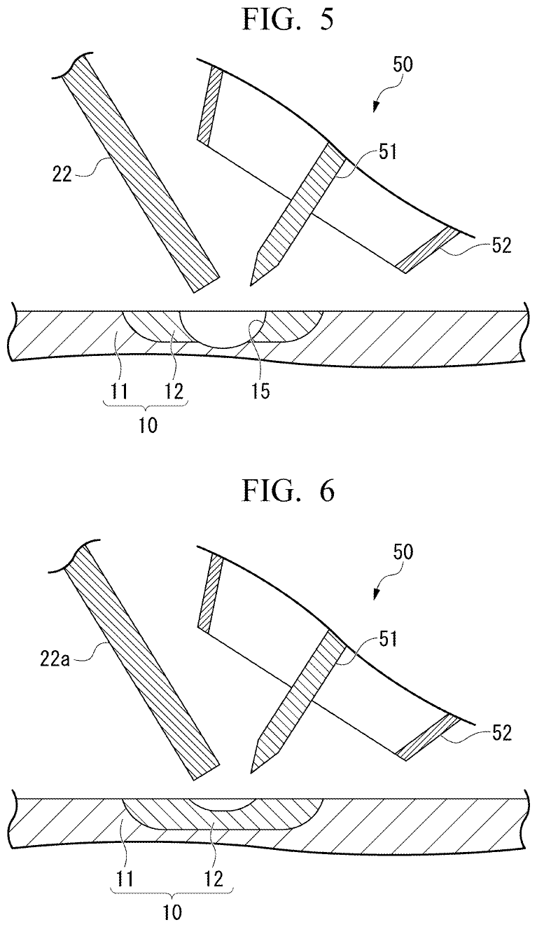

The member 10 and the cobalt-based alloy welding material 22 same as those in Example 1 were prepared. In Comparative Example 2, as illustrated in FIG. 5, the removed region 15 was formed by removing a part of the overlay welded portion 12 on a surface of the member 10 so as to expose the steel material 11. Next, the removed region 15 was heated at 200 to 300° C. by using a gas burner. The removed region 15 was inspected with a fluorescent X-ray measurement device for PMI inspection, and it was confirmed that the steel material 11 was exposed.

After the heating, the welding torch (electrode: tungsten) 50 was caused to approach the removed region 15 to generate an arc between the welding torch 50 and the removed region 15, and the melt pool 13 was formed by melting a surface of the overlay welded portion 12 with the arc.

After the melt pool 13 was formed, a repair welded portion was formed by inserting only the cobalt-based alloy welding material 22 into the melt pool 13. The weld current was 50 to 100 A, Ar was used as a shielding gas, and the flow rate was 8 to 12 L/min.

### Comparative Example 3

The member 10 same as that in Example 1 was prepared. In Comparative Example 3, the cobalt-based alloy welding material 22 was replaced with a cobalt-based alloy welding material 22a as illustrated in FIG. 6. Specifically, the cobalt-based alloy welding material 22a is a cobalt-based alloy welding material containing Fe so as to satisfy a dilution ratio.

As in Example 1, the removed region 15 was formed by removing a part of the overlay welded portion 12 on a surface of the member 10 so as not to expose the steel material 11. Next, the removed region 15 was heated at 200 to 300° C. by using a gas burner. The removed region 15 was inspected with a fluorescent X-ray measurement device for PMI inspection, and it was confirmed that the steel material 11 was not exposed.

After the heating, the welding torch (electrode: tungsten) 50 was caused to approach the removed region 15 to generate an arc between the welding torch 50 and the removed region 15, and the melt pool 13 was formed by melting a surface of the overlay welded portion 12 with the arc.

After the melt pool 13 was formed, a repair welded portion was formed by inserting only the cobalt-based alloy welding material 22a into the melt pool 13. Weld current was 50 to 100 A, Ar was used as a shielding gas, and a flow rate was 8 to 12 L/min.

### Surface Dilution Ratio

The surface dilution ratios of the repair welded portions of Examples 1 and 2 and Comparative Examples 1 to 3 were measured. The measurement was performed by a component analysis using a fluorescent X-ray device for PMI inspection. Specifically, an Fe content of a surface of the repair welded portion was measured using VANTA manufactured by Olympus Corporation, and the surface dilution ratio was evaluated based on the value of the iron (Fe) content obtained. The results are shown in Table 2. The surface dilution ratio within a range from 10 to 30% was rated as Good, and the surface dilution ratio out of the range was rated as Bad.

### Cross-Sectional Dilution Ratio

The cross-sectional dilution ratios of the repair welded portions of Examples 1 and 2 and Comparative Examples 1 to 3 were measured. The measurement was performed by a component analysis using a fluorescent X-ray device for PMI inspection. The repair welded portion was cut, and an iron (Fe) value was measured in the obtained cross-section to evaluate the cross-sectional dilution ratio. The results are shown in Table 2. The cross-sectional dilution ratio within a range from 10 to 30% was rated as Good, and the cross-sectional dilution ratio out of the range was rated as Bad.

### Cross-Sectional Observation

The cross-sections of the repair welded portions of Examples 1 and 2 and Comparative Examples 1 to 3 were observed. The observation was performed using a scanning electron microscope. The results are shown in Table 2. In the cross-sectional observation, absence of a welding failure (defect such as a crack) was rated as Good, and presence of a welding failure was rated as Bad.

TABLE 2

| | | | Compar- | Compar- | Compar- |
|---|---|---|---|---|---|
| | Ex- | Ex- | ative Ex- | ative Ex- | ative Ex- |
| | ample 1 | ample 2 | ample 1 | ample 2 | ample 3 |
| Surface | Good | Good | Bad | Good | Good |
| dilution ratio | | | | | |
| Cross-sectional | Good | Good | Good | Bad | Good |
| dilution ratio | | | | | |
| Cross-sectional | Good | Good | Good | Good | Bad |
| observation | | | | | |

As shown in Table 2, Examples 1 and 2 satisfying the conditions of the overlay welding method according to the disclosure passed all of the surface dilution ratio, the cross-sectional dilution ratio, and the cross-sectional observation. In addition, while the variation in the dilution ratio between six locations at which the welding was performed was within ±0.5% in Example 1, the variation in the dilution ratio between six locations at which the welding was performed was within ±2.0% in Example 2. As a result, it was confirmed that the variation in the dilution ratio can be reduced by inserting the similar-composition welding material 21 and the cobalt-based alloy welding material 22 into the melt pool 13 such that, along a thickness direction of the base material, a distance from a surface of the melt pool 13 to the center of the similar-composition welding material 21 is substantially equal to a distance from the surface of the melt pool 13 to the center of the cobalt-based alloy welding material 22. It was confirmed that the same results were obtained when the steel 11 was a 12Cr stainless steel.

In Comparative Example 1, since the welding was performed on the overlay welded portion 12 using the cobalt-based alloy welding material 22, the surface dilution ratio was lower than the lower limit of the surface dilution ratio. In Comparative Example 2, since the welding was performed after the removal was performed so as to expose the steel material 11, the surface dilution ratio was acceptable, but the surface dilution ratio of an initial layer exceeded the upper limit value in the cross-sectional dilution ratio. In Comparative Example 3, a defective portion was found by the cross-sectional observation.

From the above results, it was confirmed that, by using the overlay welding methods according to the disclosure, it is possible to suppress a reduction in a dilution ratio of a repair welded portion formed by repair welding of a cobalt-based alloy.

### Notes

The overlay welding methods described in the above embodiments are understood as follows.
(1) An overlay welding method according to a first aspect of the disclosure is a method of performing overlay welding on a member 10 including a steel material 11 and an overlay welded portion 12 made of a cobalt-based alloy and formed on the steel material 11, the method including generating an arc between a welding torch 50 and the overlay welded portion 12, forming a melt pool 13 by melting a surface of the overlay welded portion 12 with the arc, and simultaneously inserting a similar-composition welding material 21 having a composition similar to the steel material 11 and a cobalt-based alloy welding material 22 made of a cobalt-based alloy into the melt pool 13.

With this configuration, it is possible to suppress a reduction in a dilution ratio of a repair welded portion formed by repair welding of the cobalt-based alloy.
(2) An overlay welding method according to a second aspect of the disclosure is the overlay welding method of (1), wherein the similar-composition welding material 21 has a rod shape or a wire shape, and the cobalt-based alloy welding material 22 has a rod shape or a wire shape.

With this configuration, it is possible to further suppress a reduction in a dilution ratio of a repair welded portion formed by repair welding of the cobalt-based alloy. In addition, since the melt amount of either of the similar-composition welding material 21 and the cobalt-based alloy welding material 22 is increased, an insertion method can be appropriately changed according to the shape and the dilution ratio of a welding portion.
(3) An overlay welding method according to a third aspect of the disclosure is the overlay welding method of (2), wherein a ratio between a diameter of the cobalt-based alloy welding material 22 and a diameter of the similar-composition welding material 21 is 70:30 to 60:40.

With this configuration, it is possible to further suppress a reduction in a dilution ratio of a repair welded portion formed by repair welding of the cobalt-based alloy.
(4) An overlay welding method according to a fourth aspect of the disclosure is the overlay welding method of any one of (1) to (3), wherein the similar-composition welding material 21 is inserted into the melt pool 13 while in contact with the cobalt-based alloy welding material 22.

With this configuration, it is possible to further suppress a reduction in a dilution ratio of a repair welded portion formed by repair welding of the cobalt-based alloy.
(5) An overlay welding method according to a fifth aspect of the disclosure is the overlay welding method of (4), wherein the similar-composition welding material 21 and the cobalt-based alloy welding material 22 are inserted into the melt pool 13 such that, along a thickness direction of the steel material 11, a distance from a surface of the melt pool 13 to the center of the similar-composition welding material 21 is substantially equal to a distance from the surface of the melt pool 13 to the center of the cobalt-based alloy welding material 22.

With this configuration, it is possible to suppress a variation in a dilution ratio of a repair welded portion formed by repair welding of the cobalt-based alloy.
(6) An overlay welding method according to a sixth aspect of the disclosure is the overlay welding method of any one of (1) to (5), wherein a region where the melt pool 13 is to be formed is heated at 200° C. to 300° C.

With this configuration, it is possible to suppress cracking of a repair welded portion and a surrounding base material portion.
(7) An overlay welding method according to a seventh aspect of the disclosure is the overlay welding method of (6), wherein the region is a region obtained by removing a part of the overlay welded portion 12 to avoid exposure of the steel material 11.

With this configuration, it is possible to perform repair with a defective portion of the overlay welded portion 12 is removed.
(8) An overlay welding method according to an eighth aspect of the disclosure is the overlay welding method of any one of (1) to (7), wherein the cobalt-based alloy welding material 22 is identical to a material used to form the overlay welded portion 12.

With this configuration, it is possible to reduce a difference in composition between the overlay welded portion 12 and a repair welded portion.
(9) An overlay welding method according to a ninth aspect of the disclosure is the overlay welding method of any one of (1) to (8), wherein the steel material 11 is a 9Cr stainless steel or a 12Cr stainless steel.

With this configuration, the member 10 can obtain excellent room temperature characteristics and high temperature characteristics.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A method of performing overlay welding on a member including a steel material and an overlay welded portion made of a cobalt-based alloy and formed on the steel material, the method comprising:
generating an arc between a welding torch and the overlay welded portion;
forming a melt pool by melting a surface of the overlay welded portion with the arc; and
simultaneously inserting a similar-composition welding material having a composition similar to the steel material and a cobalt-based alloy welding material made of a cobalt-based alloy into the melt pool.

2. The overlay welding method according to claim 1, wherein the similar-composition welding material has a rod shape or a wire shape, and the cobalt-based alloy welding material has a rod shape or a wire shape.

3. The overlay welding method according to claim 2, wherein a ratio between a diameter of the cobalt-based alloy welding material and a diameter of the similar-composition welding material is 70:30 to 60:40.

4. The overlay welding method according to claim 1, wherein the similar-composition welding material is inserted into the melt pool while in contact with the cobalt-based alloy welding material.

5. The overlay welding method according to claim 4, wherein the similar-composition welding material and the cobalt-based alloy welding material are inserted into the melt pool such that, along a thickness direction of the steel material, a distance from a surface of the melt pool to a center of the similar-composition welding material is substantially equal to a distance from the surface of the melt pool to a center of the cobalt-based alloy welding material.

6. The overlay welding method according to claim 1, wherein a region where the melt pool is to be formed is heated at 200° C. to 300° C.

7. The overlay welding method according to claim 6, wherein the region is a region obtained by removing a part of the overlay welded portion to avoid exposure of the steel material.

8. The overlay welding method according to claim 1, wherein the cobalt-based alloy welding material is identical to a material used to form the overlay welded portion.

9. The overlay welding method according to claim 1, wherein the steel material is a 9Cr stainless steel or a 12Cr stainless steel.
